(19) United States
(12) Patent Application Publication
(10) Pub. No.: US 2021/0046907 A1
(43) Pub. Date: Feb. 18, 2021

(54) Vehicle Drying Assembly

(71) Applicant: Michael Varady, Maryland Heights, MO (US)

(72) Inventor: Michael Varady, Maryland Heights, MO (US)

(21) Appl. No.: 16/540,780

(22) Filed: Aug. 14, 2019

(51) Int. Cl. B60S 3/00

(52) U.S. Cl. CPC B60S 3/002; G06Q 20/18

(57) ABSTRACT

A vehicle drying assembly for hands free dying of a vehicle includes a pair of sidewalls and a roof that define a bay, which is open ended. Each of a set of blowers that is coupled to a respective sidewall is positioned so that the set of blowers is configured to blow air to dry a vehicle that passes through the bay.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to drying assemblies and more particularly pertains to a new drying assembly for hands free dying of a vehicle.

### (2) Description of Related Art Including Information Disclosed Under 37 CFR 1.97 and 1.98

The prior art relates to drying assemblies.

### BRIEF SUMMARY OF THE INVENTION

An embodiment of the disclosure meets the needs presented above by generally comprising a pair of sidewalls and a roof that define a bay, which is open ended. Each of a set of blowers that is coupled to a respective sidewall is positioned so that the set of blowers is configured to blow air to dry a vehicle that passes through the bay.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top in-use view of a vehicle drying assembly according to an embodiment of the disclosure.

FIG. 2 is a front in-use view of an embodiment of the disclosure.

FIG. 3 is a side in-use view of an embodiment of the disclosure.

FIG. 4 is a side view of an embodiment of the disclosure.

### DETAILED DESCRIPTION OF THE INVENTION

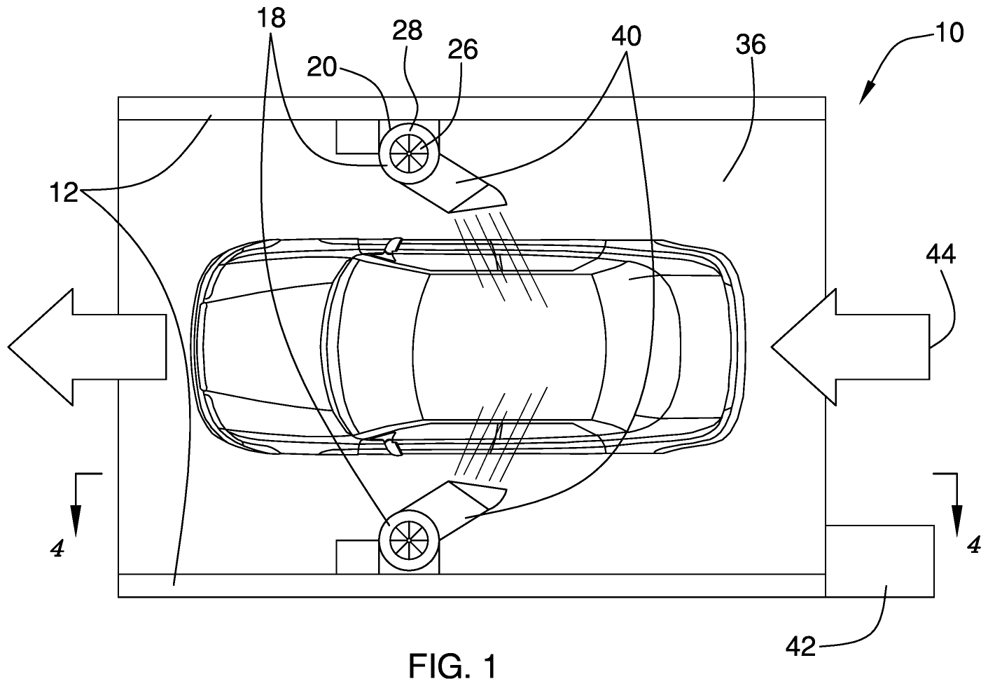

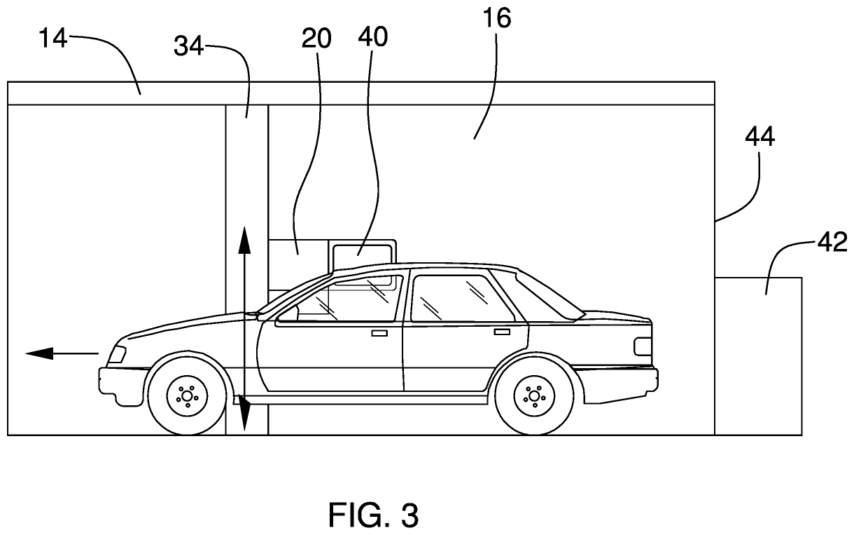

With reference now to the drawings, and in particular to FIGS. 1 through 4 thereof, a new drying assembly embodying the principles and concepts of an embodiment of the disclosure and generally designated by the reference numeral 10 will be described.

As best illustrated in FIGS. 1 through 4, the vehicle drying assembly 10 generally comprises a pair of sidewalls 12 and a roof 14 that define a bay 16, which is open ended. Each of a set of blowers 18 that is coupled to a respective sidewall 12 is positioned so that the set of blowers 18 is configured to blow air to dry a vehicle that passes through the bay 16, as shown in FIGS. 1-3. The present invention is anticipated to be utilized with a self-service car wash. Present self-service car washes may offer an option to rent a hand-held dryer, but more often users who wish to have their cars dried must do so by hand.

The set of blowers 18 may comprise two blowers 18, or other number of blowers 18, such as, but not limited to, three, four, five, or six blowers 18. The blowers 18 may be centrifugal type, or other type, such as, but not limited to, axial-flow type, cross-flow type, and the like.

Each blower 18 comprises a housing 20 that defines an interior space 22. The housing 20 has a first end 24 that is open. An aperture 26 that is positioned in the housing 20 is configured to vent the interior space 22. The aperture 26 may be positioned in a top 28 of the housing 20, as shown in FIG. 1, or in another location in the housing 20 depending on the type and orientation of blower.

A fan motor 30 is coupled to the housing 20 and is positioned in the interior space 22. The fan motor 30 is operationally coupled to an electrical circuit of a structure that comprises the bay 16, such as the self-service car wash facility. A plurality of vanes 32 is positioned in the housing 20 and is operationally coupled to the fan motor 30 so that the fan motor 30 is positioned to rotate the plurality of vanes 32 to draw the air through the aperture 26 and to expel the air through the first end 24 of the housing 20 to dry the vehicle that passes through the bay 16.

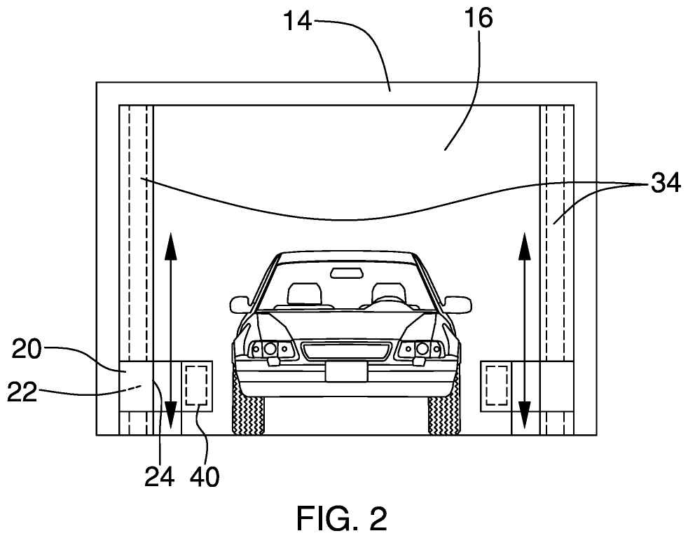

Each of a set of tracks 34 is coupled to a respective sidewall 12 so that the track 34 extends from proximate to the roof 14 to proximate to a floor 36 of the bay 16, as shown in FIG. 2. The blowers 18 of the set of blowers 18 are slidably and singly coupled to the tracks 34 so that the blowers 18 are selectively positionable between the roof 14 and the floor 36, as shown in FIGS. 2-4.

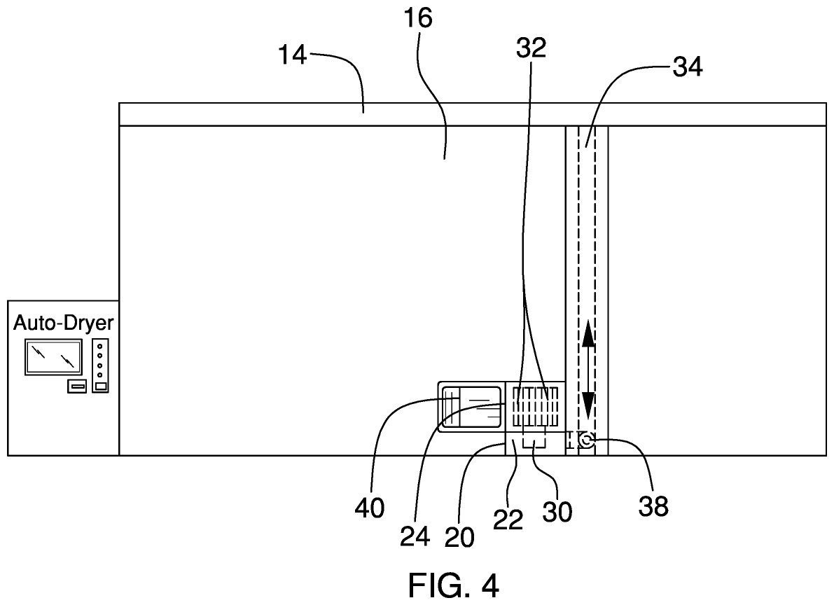

The assembly 10 also comprises a set of lift motors 38, as shown in FIG. 4. The set of lift motors 38 is operationally coupled to the electrical circuit of the structure that comprises the bay 16. Each lift motor 38 is coupled to a respective track 34 and operationally coupled to an associated blower 18 so that the lift motor 38 is positioned to selectively motivate the associated blower 18 along the respective track 34. The blowers 18 being slidable along the tracks 34 facilitates drying of all exterior surfaces of the vehicle.

Each of a set of chutes 40 is coupled to and extends from the first end 24 of a respective housing 20, as shown in FIG. 1. The chute 40 is configured to direct the air expelled from the respective housing 20 so that the air passes transversely over the vehicle that passes through the bay 16.

A control station 42 is positioned proximate to an entry 44 of the bay 16. The control station 42 is operationally coupled to the set of blowers 18, the set of lift motors 38, and the electrical circuit of the structure that comprises the bay 16. The control station 42 is pay type so that the control station 42 is configured to accept payment from a customer, positioning the control station 42 to selectively actuate the fan motors 30 and the lift motors 38 to dry the vehicle that passes through the bay 16. The control station 42 is configured to accept at least one of a credit card, a debit card, a loyalty card, cash, and coinage.

It is anticipated that an existing bay of a self-service car wash can be converted to comprise the assembly 10 by addition of the set of tracks 34, the set of lift motors 38, the set of blowers 18, and the control station 42.

In use, the user would approach the entry 44 of the bay 16 in the vehicle after utilizing the self-service car wash and stop proximate to the control station 42. After the user enters payment, the control station 42 would actuate the fan motors 30 and the lift motors 38. The user then would drive slowly through the bay 16 where the set of blowers 18 would dry the vehicle.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be only one of the elements.

I claim:

1. A vehicle drying assembly comprising:
a pair of sidewalls and a roof defining a bay, the bay being open ended; and
a set of blowers, each blower being coupled to a respective sidewall wherein the set of blowers is configured for blowing air for drying a vehicle passing through the bay.

2. The assembly of claim 1, further including the set of blowers comprising two blowers.

3. The assembly of claim 1, further including the blowers being centrifugal type.

4. The assembly of claim 2, further including each blower comprising:
a housing defining an interior space, the housing having a first end, the first end being open;
an aperture positioned in the housing wherein the aperture is configured for venting the interior space;
a fan motor coupled to the housing and positioned in the interior space, the fan motor being operationally coupled to an electrical circuit of a structure comprising the bay; and
a plurality of vanes positioned in the housing, the plurality of vanes being operationally coupled to the fan motor such that the fan motor 30 is positioned for rotating the plurality of vanes for drawing the air through the aperture and expelling the air through the first end of the housing for drying the vehicle passing through the bay.

5. The assembly of claim 1, further including the aperture being positioned in a top of the housing.

6. The assembly of claim 4, further comprising:
a set of tracks, each track being coupled to a respective sidewall such that the track extends from proximate to the roof to proximate to a floor of the bay, the blowers of the set of blowers being slidably coupled singly to the tracks such that the blowers are selectively positionable between the roof and the floor; and
a set of lift motors, the set of lift motors being operationally coupled to the electrical circuit of the structure comprising the bay, each lift motor being coupled to a respective track and operationally coupled to an associated blower such that the lift motor is positioned for selectively motivating the associated blower along the respective track.

7. The assembly of claim 4, further including a set of chutes, each chute being coupled to and extending from the first end of a respective housing wherein the chute is configured for directing the air expelled from the respective housing such that the air passes transversely over the vehicle passing through the bay.

8. The assembly of claim 6, further including a control station positioned proximate to an entry of the bay, the control station being operationally coupled to the set of blowers, the set of lift motors, and the electrical circuit of the structure comprising the bay, the control station being pay type wherein the control station is configured for accepting payment from a customer positioning the control station for selectively actuating the fan motors and the lift motors for drying the vehicle passing through the bay.

9. The assembly of claim 8, further including the control station being configured for accepting at least one of a credit card, a debit card, a loyalty card, cash, and coinage.

10. A vehicle drying assembly comprising:
a pair of sidewalls and a roof defining a bay, the bay being open ended;
a set of blowers, each blower being coupled to a respective sidewall wherein the set of blowers is configured for blowing air for drying a vehicle passing through the bay, the set of blowers comprising two blowers, the blowers being centrifugal type, each blower comprising:
a housing defining an interior space, the housing having a first end, the first end being open,
an aperture positioned in the housing wherein the aperture is configured for venting the interior space, the aperture being positioned in a top of the housing,
a fan motor coupled to the housing and positioned in the interior space, the fan motor being operationally coupled to an electrical circuit of a structure comprising the bay, and
a plurality of vanes positioned in the housing, the plurality of vanes being operationally coupled to the fan motor such that the fan motor 30 is positioned for rotating the plurality of vanes for drawing the air through the aperture and expelling the air through the first end of the housing for drying the vehicle passing through the bay;
a set of tracks, each track being coupled to a respective sidewall such that the track extends from proximate to the roof to proximate to a floor of the bay, the blowers of the set of blowers being slidably coupled singly to the tracks such that the blowers are selectively positionable between the roof and the floor;
a set of lift motors, the set of lift motors being operationally coupled to the electrical circuit of the structure comprising the bay, each lift motor being coupled to a respective track and operationally coupled to an associated blower such that the lift motor is positioned for selectively motivating the associated blower along the respective track;
a set of chutes, each chute being coupled to and extending from the first end of a respective housing wherein the chute is configured for directing the air expelled from the respective housing such that the air passes transversely over the vehicle passing through the bay; and
a control station positioned proximate to an entry of the bay, the control station being operationally coupled to the set of blowers, the set of lift motors, and the electrical circuit of the structure comprising the bay, the control station being pay type wherein the control station is configured for accepting payment from a customer positioning the control station for selectively actuating the fan motors and the lift motors for drying the vehicle passing through the bay, the control station being configured for accepting at least one of a credit card, a debit card, a loyalty card, cash, and coinage.
